(19) United States
(12) Patent Application Publication
(10) Pub. No.: US 2026/0330023 A1
(43) Pub. Date: Oct. 22, 2026

(54) SELECTIVE CONTENT PROCESSING SYSTEM FOR VULNERABILITY ASSESSMENT

(71) Applicant: CrowdStrike, Inc., Sunnyvale, CA (US)

(72) Inventor: Philip Perricone, Allentown, PA (US)

(21) Appl. No.: 19/186,292

(22) Filed: Apr. 22, 2025

(51) Int. Cl. G06F 21/57; G06F 21/55

(52) U.S. Cl. CPC G06F 21/577; G06F 21/552; G06F 21/554

(57) ABSTRACT

The present disclosure provides techniques for selective content processing for vulnerability assessment. A processing device obtains an indication of a change in at least one of: an attribute of an endpoint, or vulnerability assessment content of a vulnerability assessment engine. The processing device identifies, based on the indication of the change, a portion of the vulnerability assessment content. The processing device performs, via the vulnerability assessment engine, a vulnerability assessment of the endpoint using the portion of the vulnerability assessment content.

### TECHNICAL FIELD

Aspects of the present disclosure relate to cybersecurity, and more particularly, to a selective content processing system for vulnerability assessment.

### BACKGROUND

Cybersecurity refers to the practice of protecting computer systems, networks, and digital assets from theft, damage, unauthorized access, and various forms of cyber threats. Cybersecurity threats encompass a wide range of activities and actions that pose risks to the confidentiality, integrity, and availability of computer systems and data. These threats can include malicious activities such as viruses, ransomware, and hacking attempts aimed at exploiting vulnerabilities in software or hardware.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example of a system for selective content processing for vulnerability assessment in accordance with some aspects of the present disclosure.

FIG. 2 is a flow diagram of a method of selective content processing for vulnerability assessment in accordance with some aspects of the present disclosure.

FIG. 3 is a flow diagram of a method of selective content processing for vulnerability assessment in accordance with some aspects of the present disclosure.

FIG. 4 is a block diagram that illustrates an example of an endpoint for selective content processing for vulnerability assessment in accordance with some aspects of the present disclosure.

FIG. 5 illustrates a diagrammatic representation of a machine in an example form of a computer system that may perform one or more of the operations described herein in accordance with some aspects of the present disclosure.

### DETAILED DESCRIPTION

A vulnerability assessment engine may refer to computer-implemented instructions to promote open and publicly available security content. A vulnerability assessment engine may include functionality for representing configuration information of systems (e.g., endpoints) for testing, functionality for analyzing a system for the presence or absence of a specified machine state (e.g., vulnerability, configuration, patch state, etc.), and functionality for reporting a result of the analysis. A vulnerability assessment engine may be used to enable automated checks for security issues across different platforms and tools by providing a common language to describe system configurations and engines. An example of a vulnerability assessment engine may include an Open Vulnerability and Assessment Language (OVAL®) engine. An OVAL® engine may include an OVAL® System characteristics schema for representing system information, an OVAL® Definition schema for expressing a specific machine state, and an OVAL® Results schema for reporting results of an assessment.

Some vulnerability assessment engines (e.g., open-source and proprietary OVAL® engines) process each definition in a set of definitions during each evaluation cycle. As used herein, the terms “definition” and “vulnerability assessment definition” refer to a computer-readable file that encodes details of a specific machine state that enables the testing of a system (e.g., an endpoint) to be automated. Examples of definitions may include a vulnerability definition which indicates that a system is vulnerable when specific conditions are met, a patch definition which defines conditions indicating whether a patch is appropriate for a system, an inventory definition which defines if a particular piece of software (i.e., computer-executable instructions) is installed or identified on a system, and a compliance definition which defines if a system complies with a specific policy or configuration. A vulnerability assessment engine may obtain details of a system (e.g., an endpoint) based on definition(s), compare the details to an expected state of the system, and output an indication as to whether the system is vulnerable based on the comparison. In a specific example, a vulnerability engine may utilize definition(s) to determine whether a computing device executing a particular operating system (OS) is vulnerable to a common vulnerability and exposure (CVE).

As a vulnerability may continue to exist even after the vulnerability is patched, a number of definitions (e.g., OVAL® definitions) used to determine whether an endpoint is vulnerable to a security threat may continue to grow. For example, a definition for even a relatively old vulnerability may be maintained by a vulnerability assessment engine in the case that at endpoint that has not been connected to a network (e.g., the Internet) connects to the network in order for the endpoint to be tested and protected against the relatively old vulnerability. The continual growth in the number of definitions associated with a vulnerability assessment engine may lead to increased usage of computing resources (e.g., increased processor clock cycles, increased memory usage, increased power usage, etc.) of an endpoint. For example, the endpoint may continue to check each definition of a set of definitions during each evaluation cycle of the vulnerability assessment engine, which can degrade performance of the endpoint.

The present disclosure addresses the above-noted and other deficiencies by using a processing device to perform selective content processing for vulnerability assessment. In an example, the processing device may determine that an attribute (e.g., a patch version) of an endpoint has changed and/or vulnerability assessment content (e.g., a definition) of a vulnerability assessment engine has changed. The processing device may identify a portion of the vulnerability assessment content associated with the change. In one example with respect to an attribute change, the processing device may maintain a mapping between the attribute of the endpoint and the portion of the vulnerability assessment content. If the processing device determines that the attribute changes, the processing device may identify the portion of the vulnerability assessment content based on the mapping. The portion of the vulnerability assessment content may correspond to content that is associated with the changed attribute of the endpoint (and not to content of the vulnerability assessment content not associated with the changed attribute). In another example with respect to a vulnerability assessment content change, the processing device may determine (i.e., compute) a difference between a first version (i.e., an old version) of the vulnerability assessment content and a second version (i.e., a new version) of the vulnerability assessment content. The processing device may identify the portion of the vulnerability assessment content based on the difference. The portion of the vulnerability assessment content may correspond to content that has changed between the first version and the second version (and not content that has not changed between the first version and the second version). The processing device may then perform a vulnerability assessment using the portion of the vulnerability assessment content. For example, if an attribute of the endpoint has changed, the processing device may perform the vulnerability assessment using content that is associated with the changed attribute (and not using content that is unassociated with the changed attribute). For example, if the vulnerability assessment content has changed, the processing device may perform the vulnerability assessment using content that has changed (and not using content that has not changed). Thus, the processing device may conserve use of computing resources used in performing a vulnerability assessment via the selective choosing of vulnerability assessment content.

In an example, a processing device obtains an indication of a change in at least one of: an attribute of an endpoint or vulnerability assessment content of a vulnerability assessment engine. The processing device identifies, based on the indication of the change, a portion of the vulnerability assessment content. The processing device performs, via the vulnerability assessment engine, a vulnerability assessment of the endpoint using the portion of the vulnerability assessment content.

As discussed herein, the present disclosure provides an approach that improves the operation of a computer system by reducing an amount of computing resources used to perform a vulnerability assessment. For example, by identifying a portion of vulnerability assessment content (e.g., an OVAL® definition) based on an indication of a change in at least one of an attribute of an endpoint or vulnerability assessment content of a vulnerability assessment engine, the computer system may perform a vulnerability assessment using content that is related to the change (and not using content that is not related to the change), which may conserve computing resources (e.g., processor clock cycles, memory usage, power consumption, etc.) compared to a computer system that does not perform selective content processing for vulnerability assessment as described herein. In addition, the present disclosure provides an improvement to the technological field of cybersecurity by improving performance of a vulnerability assessment engine. For instance, the vulnerability assessment engine may skip vulnerability assessments that are based on content not associated with the change, which may lead to a more rapid identification of a security threat compared to a vulnerability assessment engine that rechecks all vulnerability assessment content each time a change occurs with respect to the vulnerability assessment content and/or an attribute of an endpoint.

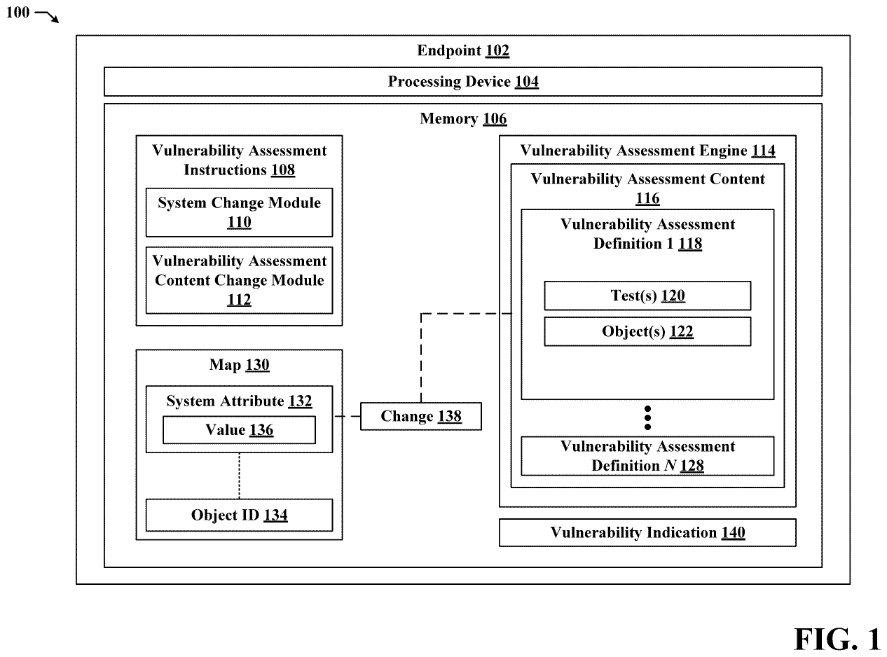

FIG. 1 is a block diagram 100 that illustrates an example of a system for selective content processing for vulnerability assessment in accordance with some aspects of the present disclosure. The system includes an endpoint 102 (i.e., a computing device, a computing system, a computer system, etc.). In an example, the endpoint 102 may be or include a desktop computing device, a laptop computing device, a tablet computing device, a smartphone, a gaming console, a wearable computing device, an extended reality (XR) device, and/or a server computing device. In an example, the endpoint 102 may be or include the computer system 500 (or a portion thereof).

The endpoint 102 includes a processing device 104 (e.g., a central processing unit (CPU)) and memory 106. The memory 106 may store vulnerability assessment instructions 108. The vulnerability assessment instructions 108, when executed by the processing device 104, cause the processing device 104 to implement functionality pertaining to selective content processing for vulnerability assessment as described herein. The vulnerability assessment instructions 108 may include a system change module 110 that is configured to perform persistent tracking of system attributes (i.e., attributes of the endpoint 102) for the purpose of selective content processing (described in greater detail below). The vulnerability assessment instructions 108 may include a vulnerability assessment content change module 112 that is configured to identify changes in vulnerability assessment content for the purpose of selective content processing (described in greater detail below). Although not illustrated in FIG. 1, it is to be understood that the endpoint 102 may elements not depicted in FIG. 1 (e.g., a network interface device, input devices, output devices, etc.).

The memory 106 may store a vulnerability assessment engine 114. The vulnerability assessment engine 114, when executed by the processing device 104, may cause the processing device 104 to perform functionality pertaining to vulnerability assessment with respect to the endpoint 102. In an example, the vulnerability assessment engine 114 may be or include an OVAL® engine, such as an open-source OVAL® engine or a proprietary OVAL® engine.

The vulnerability assessment engine 114 may include and/or be associated with vulnerability assessment content 116. In general, the vulnerability assessment content 116 may include computer-executable instructions for assessing whether endpoints (e.g., the endpoint 102) are vulnerable to a security threat (e.g., a cybersecurity threat).

In an example, the vulnerability assessment content 116 may include a first vulnerability assessment definition 118. The first vulnerability assessment definition 118 may include data associated with assessing whether the endpoint 102 is vulnerable to a security threat. In an example, the first vulnerability assessment definition 118 may be or include an OVAL® definition. In an example, the first vulnerability assessment definition 118 may be included in an extensible markup language (XML) file.

The first vulnerability assessment definition 118 may include test(s) 120. The test(s) 120 may include logical statement(s), where each logical statement in the logical statement(s) defines an expected state of the endpoint 102 by specifying an attribute (i.e., a value of an attribute) of the endpoint 102 and an expected state of the attribute (i.e., an expected value of the attribute). The vulnerability assessment engine 114 may utilize results of the test(s) to determine whether the endpoint 102 is vulnerable to a security threat or not vulnerable to the security threat. In some aspects, the test(s) 120 may evaluate to true or false based on the attribute of the endpoint 102 and the expected state of the attribute. In some aspects, the test(s) 120 may include a test for determining whether the attribute of the endpoint 102 is greater than, less than, or equal to the expected state of the attribute. In a specific example, the test(s) may include a test for determining whether a value of a registry key of the endpoint 102 is equal to a particular value. If the value of the registry key is equal to the particular value, the test evaluates to true, whereas if the value of the registry key is not equal to the particular value, the test evaluates to false.

The first vulnerability assessment definition 118 may include object(s) 122. The object(s) 122 may specify data (e.g., attributes) that are to be collected from the endpoint 102 for running the test(s) 120. In an example, the object(s) 122 may include a reference to a directory path of the endpoint 102 from which an attribute (e.g., a registry value) of the endpoint 102 is to be collected.

The vulnerability assessment content 116 may include an Nth vulnerability assessment definition 128, where N is a positive integer greater than one. The first vulnerability assessment definition 118 and the Nth vulnerability assessment definition 128 may be collectively referred to as “a plurality of vulnerability assessment content.” The Nth vulnerability assessment definition 128 may include test(s) and object(s) 122 similar to that of the first vulnerability assessment definition 118. In one example, the first vulnerability assessment definition 118 may be for assessing whether a system that runs a first type of OS is vulnerable to a security threat, and the Nth vulnerability assessment definition 128 may be for assessing whether a system that runs a second type of OS is vulnerable to the security threat. In another example, the first vulnerability assessment definition 118 may be for assessing whether a system is vulnerable to a first security threat, and the Nth vulnerability assessment definition 128 may be for assessing whether the system is vulnerable to a second security threat that is different from the first security threat. As used herein, a system (e.g., the endpoint 102) that is “vulnerable to a security threat” may refer to the system being in a state that is able to be exploited by a malicious actor. Although not depicted in FIG. 1, it is to be understood that the vulnerability assessment content 116 may include content other than what is depicted in FIG. 1, such as sub-constructs of vulnerability assessment definitions, where the sub-constructs may include states and variables.

The endpoint 102 (e.g., via the system change module 110 of the vulnerability assessment instructions 108) may generate a map 130. The endpoint 102 (or another computing device) may generate the map 130 during initial ingestion of the vulnerability assessment content 116 (i.e., when the endpoint 102 first obtains the vulnerability assessment content 116). For instance, the endpoint 102 (or another computing device) may generate the map 130 by traversing an XML tree graph included in or associated with the vulnerability assessment content 116. The endpoint 102 (or another computing device) may update the map 130 when new content is added to the vulnerability assessment content 116. The map 130 maps a system attribute 132 of the endpoint 102 to an object identifier (ID) 134. In an example, the system attribute 132 may be or include a file, a registry key, a process, and/or a version number of the endpoint 102. As such, the system attribute 132 may include a value 136. In a specific example, the system attribute 132 may be a version of an application that executes on the endpoint 102 and the value 136 may be “1.00,” “1.10,” or “1.11,” The object ID 134 may be an identifier for an object in the vulnerability assessment content 116. For example, the object ID 134 may be an identifier for the object(s) 122 of the first vulnerability assessment definition 118.

The endpoint 102 may obtain an indication of a change 138 that occurs with respect to the system attribute 132 and/or the vulnerability assessment content 116. In some aspects, the endpoint 102 may determine the change 138 by monitoring the system attribute 132 and/or the vulnerability assessment content 116. In some aspects, a computing device (not shown in FIG. 1) may determine that the change 138 has occurred (or will occur), and the computing device provides (e.g., transmits) the indication of the change 138 to the endpoint 102 and the endpoint 102 receives the indication of the change 138 from the computing device.

In an example with respect to the system attribute 132, the value 136 of the system attribute 132 may change from “v1.0” to “v1.1.” The endpoint 102 may determine (e.g., via the system change module 110) that the value 136 of the system attribute 132 has changed. In an example with respect to the vulnerability assessment content 116, the vulnerability assessment content 116 may change from a first version to a second version. For instance, the first vulnerability assessment definition 118 may be a first version, and the endpoint 102 may obtain a second version (not depicted in FIG. 1) of the first vulnerability assessment definition 118. The endpoint 102 (e.g., via the vulnerability assessment content change module 112) may compute a difference between the first version of the first vulnerability assessment definition 118 and the second version of the first vulnerability assessment definition 118 to determine the change 138. In an example, the difference may indicate section(s) (e.g., portions of XML) that have changed between the first version and the second version. In another example with respect to a vulnerability assessment content change, the endpoint 102 may receive, from a computing device (not depicted in FIG. 1), an indication of the change in the vulnerability assessment content 116.

The endpoint 102 (e.g., via the system change module 110 and/or the vulnerability assessment content change module 112) may identify a portion of the vulnerability assessment content 116 based on the indication of the change 138. In an example with respect to a system change, the endpoint 102 may identify (e.g., via the system change module 110) the system attribute 132 in the map 130. The endpoint 102 may identify that the value 136 of the system attribute 132 has changed. The endpoint 102 may determine the object ID 134 based on the mapping in the map 130 between the system attribute 132 and the object ID 134 in the map 130. The endpoint 102 may identify the portion of the vulnerability assessment content 116 based on the object ID 134. For example, the endpoint 102 may determine that the object ID 134 corresponds to the object(s) 122 of the first vulnerability assessment definition 118. In the example, the endpoint 102 may identify the first vulnerability assessment definition 118 (i.e., a portion of the vulnerability assessment content 116) based on the object ID 134 corresponding to the object(s) 122.

In another example with respect to a vulnerability assessment content change, the vulnerability assessment content 116 may be a first version, and the endpoint 102 may obtain a second version (not depicted in FIG. 1) of the vulnerability assessment content 116. The endpoint 102 may compute a difference (described above) between the first version and the second version. In an example, the difference indicates that the test(s) 120 of the first vulnerability assessment definition 118 (i.e., a portion of the vulnerability assessment content 116) have changed between the first version and the second version. In the example, the endpoint 102 also determines that the Nth vulnerability assessment definition 128 has not changed.

The endpoint 102 may perform, via the vulnerability assessment engine 114, a vulnerability assessment of the endpoint 102 based on the portion of the vulnerability assessment content 116. The endpoint 102 may additionally perform the vulnerability assessment based on the system attribute 132 (and/or another system attribute). The endpoint 102 may perform the vulnerability assessment of the endpoint 102 during an evaluation cycle of the vulnerability assessment engine 114. Performing the vulnerability assessment may include performing a test (e.g., the test(s) 120) on the value 136 of the system attribute 132 (or another system attribute). For example, performing the vulnerability assessment may include comparing the value 136 of the system attribute 132 with an expected value of the system attribute 132 indicated by the test(s) 120. In an example, the portion of the vulnerability assessment content 116 that has changed may include the first vulnerability assessment definition 118 (and not the Nth vulnerability assessment definition 128). The endpoint 102 may perform the vulnerability assessment using the first vulnerability assessment definition 118 (and not the Nth vulnerability assessment definition 128) based on the change 138. In one example, the first vulnerability assessment definition 118 may have changed, but the Nth vulnerability assessment definition 128 may not have changed, and as such the endpoint 102 may skip (re)evaluation of the Nth vulnerability assessment definition 128 during the vulnerability assessment. In another example, the value 136 of the system attribute 132 has changed, but the change does not impact the Nth vulnerability assessment definition 128, and as such, the endpoint 102 may skip reevaluation of the Nth vulnerability assessment definition 128 during the vulnerability assessment. In this manner, the endpoint 102 may reduce usage of computing resources (e.g., processor clock cycles of the processing device 104) by selectively evaluating vulnerability assessment content (i.e., the portion of the vulnerability assessment content 116) that is relevant to the change 138 while skipping (re)evaluation of vulnerability assessment content that is not relevant to the change 138.

The endpoint 102 may output an indication as to whether the endpoint 102 is vulnerable (i.e., a vulnerability indication 140) to a security threat based on the performed vulnerability assessment. For instance, the endpoint 102 may output the vulnerability indication 140 when results for the vulnerability assessment indicate that the endpoint 102 is vulnerable to the security threat. In one example, the endpoint 102 may store the vulnerability indication 140 in the memory 106. In another example, the endpoint 102 may present the vulnerability indication 140 on a display (not depicted in FIG. 1). In a further example, the endpoint 102 may transmit the vulnerability indication 140 over a network to a computing device. In some aspects, the endpoint 102 may perform action(s) to address the vulnerability to the security threat based on the performed vulnerability assessment. For example, the endpoint 102 may request and install a patch to address the vulnerability.

Although the vulnerability assessment instructions 108 (including the system change module 110 and the vulnerability assessment content change module 112) are described above as being separate from the vulnerability assessment engine 114, other possibilities are contemplated. In some aspects, the vulnerability assessment instructions 108 (including the system change module 110 and/or the vulnerability assessment content change module 112) may be incorporated into the vulnerability assessment engine 114.

The OVAL® specification may be used to evaluate system characteristics against defined conditions in order to determine if machines (e.g., a computing device) is vulnerable to security threat(s). As a vulnerability may persist conceptually even after the vulnerability is addressed (e.g., via a patch), a number of OVAL® definitions may continuously grow. The aforementioned growth may lead to performance degradation and increased resource consumption during evaluation instances, as some OVAL® evaluation engines may reiterate through all OVAL® definitions regardless of relevance to recent system changes. With more particularity, some OVAL® evaluation engines, both open-source and proprietary, may process all definitions during each evaluation cycle. This approach may lack optimization as such an approach does not consider whether system changes actually impact specific OVAL® definitions. Some OVAL® evaluation engines may operate in isolation without considering a broader system context, which may make implementing intelligent processing decisions based on system changes and/or OVAL® content updates difficult or impossible.

Some aspects described herein pertain to a system that optimizes OVAL® processing by selectively evaluating relevant OVAL® content (and not irrelevant OVAL® content) using two specialized modules that work in conjunction with an OVAL® engine.

A first module may implement persistent tracking of system characteristic data changes. The first module may maintain a mapping between OVAL® object identifiers (IDs) and corresponding machine data points. When system changes occur, the first module may perform a reverse lookup to identify affected OVAL® object IDs. The first module may subsequently determine which OVAL® tests and definitions are to be reevaluated based on the affected OVAL® object IDs. The first module may create the mapping during initial OVAL® content ingestion by traversing an extensible markup language (XML) tree graph. The first module may update the mapping whenever new OVAL® content is loaded.

In some aspects, the first module may implement a tracking mechanism using hash maps, where OVAL® object IDs may serve as keys that resolve to list(s) of affected OVAL® definitions. The tracking mechanism may include traversing all criteria and nested criteria within each OVAL® definition. The tracking mechanism may include identifying object references through two primary paths: direct references via criterions and indirect references using extend definitions (i.e., “ExtendDefinitions”). The tracking mechanism may include processing complex reference chains involving OVAL® variables, OVAL® sets (with potentially recursive relationships), and/or traversing intermediary nodes until reaching terminal leaf nodes (unique objects). The tracking mechanism may include mapping tests to objects associated with the tests. The tracking mechanism may include creating final object-to-definition mappings through test references.

A second module may analyze differences between OVAL® definition documents to determine if OVAL® content changes should cause reevaluation. The second module may process several specific conditions: introduction of new OVAL® definitions, modifications to existing OVAL® definitions, modifications or additions of sub-constructs (e.g., tests, states, objects, variables) of OVAL® definitions, and changes that could impact evaluation results. The second module may rely upon version attribute increments of OVAL® content during content curation in order to identify meaningful logic modifications of the OVAL® content.

The second module may determine which OVAL® content is to be reevaluated based on two construct types: objects (data collection points) and states (evaluation criteria). The objects (data collection points) may include and/or be associated with changes to field values that affect data collection, references to sets and variables (both supporting recursive relationships), and/or changes to any construct in a reference chain. The states (evaluation criteria) may include or be associated with modifications to comparison operators, changes to field values used in comparisons, references to variables (supporting recursive relationships), alterations to type-specific fields (e.g., a registry state value), and/or changes to any construct in reference chains. The second module may utilize an efficient lookup mechanism to manage the objects (data collection points) and states (evaluation criteria) during processing. In some aspects, hash maps (or another data structure or mechanism) may be used to provide efficient relationship lookups during processing. In some aspects, the second module may quickly resolve OVAL® object IDs to their associated definitions when system changes occur.

Together, the first module and the second module may enable the system to identify a subset of OVAL® content that is to undergo (re)processing based on both system changes and OVAL® content updates. This selective processing approach may eliminate having to evaluate all OVAL® definitions during each assessment cycle. With more particularity, the persistent tracking system in the first module that maps system characteristics to OVAL® objects may enable targeted evaluations based on system changes. The implementation of content difference analysis in the second module may identify which OVAL® definition changes may cause reevaluation to be performed. The first module and the second module may provide a comprehensive system that combines system change tracking and content difference analysis in order to determine a minimal set of OVAL® content that is to be evaluated. The approach to OVAL® processing described herein may eliminate performance of complete content iteration during each evaluation instance of an OVAL® engine.

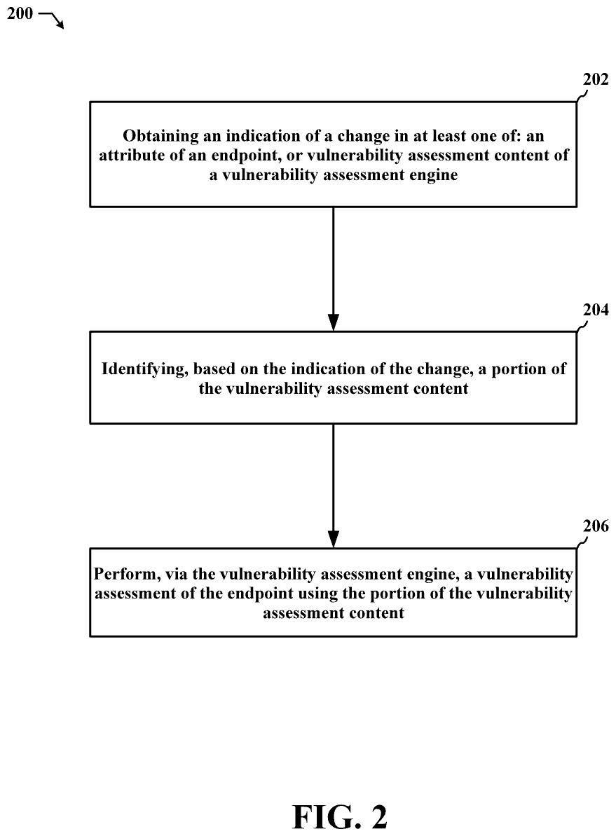

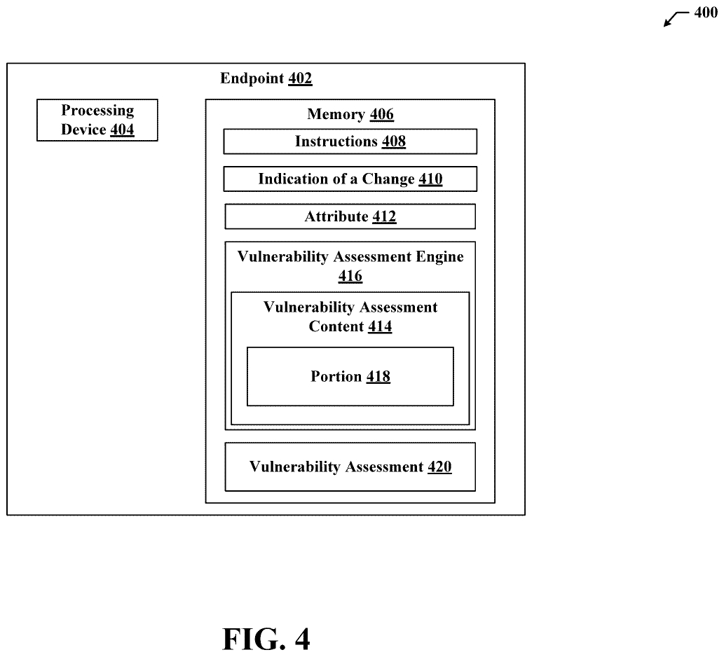

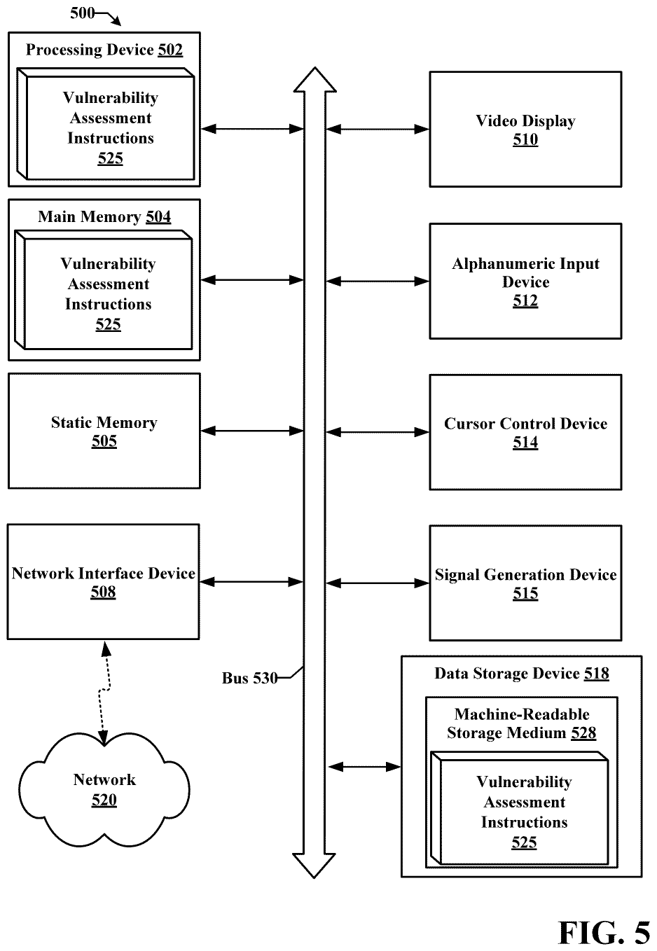

FIG. 2 is a flow diagram 200 of a method for selective content processing for vulnerability assessment in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the endpoint 102 (shown in FIG. 1), the processing device 104 (shown in FIG. 1), the endpoint 402 (shown in FIG. 4), the processing device 404 (shown in FIG. 4), the processing device 502 (shown in FIG. 5), the computer system 500 (shown in FIG. 5), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 202, a processing device obtains an indication of a change in at least one of: an attribute of an endpoint, or vulnerability assessment content of a vulnerability assessment engine. For example, the indication of the change may correspond to the change 138 in FIG. 1, the attribute may be or include the system attribute 132, the endpoint may be or include the endpoint 102, the vulnerability assessment content may be or include the vulnerability assessment content 116, and the vulnerability assessment engine 114 may be or include the vulnerability assessment engine 114. In another example, the indication of the change may be or include the indication of the change 410, the attribute may be or include the attribute 412, the endpoint may be or include the endpoint 402, the vulnerability assessment content may be or include the vulnerability assessment content 414, and the vulnerability assessment engine may be or include the vulnerability assessment engine 416.

At block 204, the processing device identifies, based on the indication of the change, a portion of the vulnerability assessment content. In an example, the portion of the vulnerability assessment content may be or include the first vulnerability assessment definition 118 (and not the Nth vulnerability assessment definition 128). In another example, the portion of the vulnerability assessment content may be or include the portion 418. In yet another example, the portion of the vulnerability assessment content may be a portion (i.e., not a complete portion) of the first vulnerability assessment definition 118.

At block 206, the processing device performs, via the vulnerability assessment engine, a vulnerability assessment of the endpoint using the portion of the vulnerability assessment content. For example, the endpoint 102 may perform, via the vulnerability assessment engine 114, a vulnerability assessment of the endpoint 102 using the first vulnerability assessment definition 118 (and not the Nth vulnerability assessment definition 128). In yet another example, the vulnerability assessment may be or include the vulnerability assessment 420.

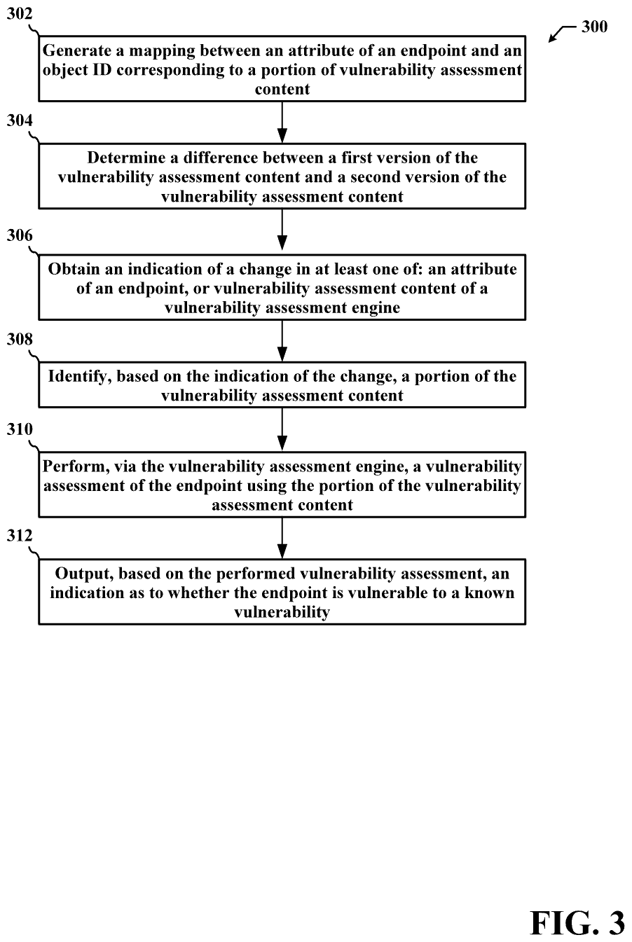

FIG. 3 is a flow diagram 300 of a method for selective content processing for vulnerability assessment in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the endpoint 102 (shown in FIG. 1), the processing device 104 (shown in FIG. 1), the endpoint 402 (shown in FIG. 4), the processing device 404 (shown in FIG. 4), the processing device 502 (shown in FIG. 5), the computer system 500 (shown in FIG. 5), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

In some aspects, at block 302, a processing device may generate a mapping between an attribute of an endpoint and an object identifier (ID) corresponding to a portion of the vulnerability assessment content. Identifying a portion of the vulnerability assessment content may include identifying the portion of the vulnerability assessment content based on the mapping. For example, the mapping may be or include the map 130, the attribute may be or include the system attribute 132, the endpoint may be or include the endpoint 102, the object ID may be or include the object ID 134, and the vulnerability assessment content may be or include the vulnerability assessment content 116. In another example, the endpoint may be or include the endpoint 402, the vulnerability assessment content may be or include the vulnerability assessment content 414, and the portion of the vulnerability assessment content may be or include the portion 418.

In some aspects, at block 304, the processing device may determine a difference between a first version of the vulnerability assessment content and a second version of the vulnerability assessment content. Identifying the portion of the vulnerability assessment content may be based on the difference. For example, the aforementioned aspect may correspond to functionality performed by the vulnerability assessment content change module 112 described above in the description of FIG. 1.

At block 306, the processing device obtains an indication of a change in at least one of: an attribute of an endpoint, or vulnerability assessment content of a vulnerability assessment engine. For example, the indication of the change may correspond to the change 138 in FIG. 1, the attribute may be or include the system attribute 132, the endpoint may be or include the endpoint 102, the vulnerability assessment content may be or include the vulnerability assessment content 116, and the vulnerability assessment engine 114 may be or include the vulnerability assessment engine 114. In another example, the indication of the change may be or include the indication of the change 410, the attribute may be or include the attribute 412, the endpoint may be or include the endpoint 402, the vulnerability assessment content may be or include the vulnerability assessment content 414, and the vulnerability assessment engine may be or include the vulnerability assessment engine 416.

At block 308, the processing device identifies, based on the indication of the change, a portion of the vulnerability assessment content. In an example, the portion of the vulnerability assessment content may be or include the first vulnerability assessment definition 118 (and not the Nth vulnerability assessment definition 128). In another example, the portion of the vulnerability assessment content may be or include the portion 418. In yet another example, the portion of the vulnerability assessment content may be a portion (i.e., not a complete portion) of the first vulnerability assessment definition 118.

At block 310, the processing device performs, via the vulnerability assessment engine, a vulnerability assessment of the endpoint using the portion of the vulnerability assessment content. For example, the endpoint 102 may perform, via the vulnerability assessment engine 114, a vulnerability assessment of the endpoint 102 using the first vulnerability assessment definition 118 (and not the Nth vulnerability assessment definition 128). In yet another example, the vulnerability assessment may be or include the vulnerability assessment 420.

In some aspects, at block 312, the processing device may output, based on the performed vulnerability assessment, an indication as to whether the endpoint is vulnerable to a known vulnerability. For example, the indication as to whether the endpoint is vulnerable to a known vulnerability may be or include the vulnerability indication 140.

In some aspects, the vulnerability assessment engine may include an Open Vulnerability and Assessment Language (OVAL®) engine, and the vulnerability assessment content may include OVAL® content. For example, the vulnerability assessment engine 114 may be or include an OVAL® engine, and the vulnerability assessment content 116 may be or include OVAL® content.

In some aspects, the vulnerability assessment content may include vulnerability assessment definitions for vulnerabilities including logical statements defining an expected state of the endpoint by specifying the attribute and an expected state of the attribute, the identifying the portion of the vulnerability assessment content may include identifying a vulnerability assessment definition in the vulnerability assessment definitions, and the performing the vulnerability assessment may include performing the vulnerability assessment using the vulnerability assessment definition. For example, the vulnerability assessment definitions may be or include the first vulnerability assessment definition 118 and the Nth vulnerability assessment definition 128.

In some aspects, the vulnerability assessment content may include a vulnerability assessment definition for a vulnerability including logical statements defining an expected state of the endpoint by specifying the attribute and an expected state of the attribute, the identifying the portion of the vulnerability assessment content may include identifying a logical statement in the logical statements, and the performing the vulnerability assessment may include performing the vulnerability assessment using the logical statement. For example, the first vulnerability assessment definition 118 may include logical statements defining an expected state of the endpoint by specifying the attribute and an expected state of the attribute.

In some aspects, the change in the vulnerability assessment content may include at least one of: a creation of a new vulnerability assessment definition, a change to an existing vulnerability assessment definition, or a change to a sub-construct of the existing vulnerability assessment definition. For example, the change 138 may include or be associated with a creation of a new vulnerability assessment definition, a change to an existing vulnerability assessment definition, and/or a change to a sub-construct of the existing vulnerability assessment definition.

In some aspects, the attribute may include at least one of: an operating system property, or an installed application property. For example, the system attribute 132 may include at least one of: an operating system property, or an installed application property.

In some aspects, the performing the vulnerability assessment may include determining whether a value of the attribute is greater than, less than, or equal to an expected value of the attribute indicated by the portion of the vulnerability assessment content. For example, performing the vulnerability assessment may include determine whether the value 136 of the system attribute 132 is greater than, less than, or equal to an expected value of the attribute indicated by or associated with the test(s) 120 of the first vulnerability assessment definition 118.

In some aspects, the vulnerability assessment content may include the portion of the vulnerability assessment content and a second portion of the vulnerability assessment content, and the performing the vulnerability assessment may include performing the vulnerability assessment using the portion of the vulnerability assessment content while skipping the second portion of the vulnerability assessment content. For example, the portion of the vulnerability assessment content may be or include the first vulnerability assessment definition 118 and the second portion of the vulnerability assessment content may be or include the Nth vulnerability assessment definition 128

In some aspects, the obtaining the indication of the change may include detecting the change at the endpoint. For example, the endpoint 102 may detect the change 138 at the endpoint 102.

In some aspects, the performing the vulnerability assessment may include performing the vulnerability assessment during an assessment instance of an assessment cycle of the vulnerability assessment engine. For example, performing the vulnerability assessment may include performing the vulnerability assessment during an assessment instance of an assessment cycle of the vulnerability assessment engine 114.

In some aspects, the vulnerability assessment content may include a plurality of tests, and the portion of the vulnerability assessment content may include a test in the plurality of tests. For example, the plurality of tests may be or include the test(s) 120, and the portion of the vulnerability assessment content may be or include a test in the test(s) 120.

In some aspects, performing the vulnerability assessment of the endpoint may additionally be based on the attribute of the endpoint. For example, the endpoint 102 may perform the vulnerability assessment additionally based on the (value of) the system attribute 132. The (value) of the system attribute 132 may or may not be a changed valued.

FIG. 4 is a block diagram 400 that illustrates an example of an endpoint 402 for selective content processing for vulnerability assessment in accordance with some aspects of the present disclosure. In some aspects, the endpoint 402 may perform some or all of the functionality described herein. The endpoint 402 includes a processing device 404 and memory 406. The memory 406 stores instructions 408 that are executed by the processing device 404. The instructions 408, when executed by the processing device 404, cause the processing device 404 to obtain an indication of a change 410 in at least one of: an attribute 412 of an endpoint 402, or vulnerability assessment content 414 of a vulnerability assessment engine 416. The instructions 408, when executed by the processing device 404, cause the processing device 404 to identify, based on the indication of the change 410, a portion 418 of the vulnerability assessment content 414. The instructions 408, when executed by the processing device 404, cause the processing device 404 to perform, via the vulnerability assessment engine 416, a vulnerability assessment 420 of the endpoint 402 using the portion 418 of the vulnerability assessment content 414 and the attribute 412 of the endpoint 402.

FIG. 5 illustrates a diagrammatic representation of a machine in the example form of a computer system 500 within which a set of instructions, for causing the machine to perform any one or more of the methodologies discussed herein for selective content processing for vulnerability assessment.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, the computer system 500 may be representative of a server.

The computer system 500 includes a processing device 502, a main memory 504 (e.g., read-only memory (ROM), flash memory, dynamic random access memory (DRAM), a static memory 505 (e.g., flash memory, static random access memory (SRAM), etc.), and a data storage device 518 which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., an acoustic signal generation device, such as a speaker). In some embodiments, the video display unit 510, the alphanumeric input device 512, and the cursor control device 514 may be combined into a single component or device (e.g., an LCD touch screen).

The processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute vulnerability assessment instructions 525, for performing the operations and steps discussed herein. For example, the vulnerability assessment instructions 525 may include instructions for obtaining an indication of a change in at least one of: an attribute of an endpoint, or vulnerability assessment content of a vulnerability assessment engine. The vulnerability assessment instructions 525 may include instructions for identifying, based on the indication of the change, a portion of the vulnerability assessment content. The vulnerability assessment instructions 525 may include instructions for performing, via the vulnerability assessment engine, a vulnerability assessment of the endpoint using the portion of the vulnerability assessment content.

The data storage device 518 may include a machine-readable storage medium 528 that stores the vulnerability assessment instructions 525 (e.g., software) embodying any one or more of the methodologies of functions described herein. The vulnerability assessment instructions 525 may also reside, completely or at least partially, within the main memory 504 or within the processing device 502 during execution thereof by the computer system 500; the main memory 504 and the processing device 502 also constituting machine-readable storage media. The vulnerability assessment instructions 525 may further be transmitted or received over a network 520 via the network interface device 508.

While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “obtaining,” “identifying,” “performing,” “generating,” “determining,” “mapping,” “detecting,” “changing,” “selecting,” “executing,” “inputting,” “outputting,” “transmitting,” “receiving,” “storing,” “assessing,” “mapping,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission, or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
obtaining an indication of a change in at least one of:
an attribute of an endpoint, or
vulnerability assessment content of a vulnerability assessment engine;
identifying, by a processing device and based on the indication of the change, a portion of the vulnerability assessment content; and
performing, via the vulnerability assessment engine, a vulnerability assessment of the endpoint using the portion of the vulnerability assessment content.

2. The method of claim 1, wherein the vulnerability assessment engine comprises an Open Vulnerability and Assessment Language (OVAL®) engine, and wherein the vulnerability assessment content comprises OVAL® content.

3. The method of claim 1, further comprising:
generating a mapping between the attribute of the endpoint and an object identifier (ID) corresponding to the portion of the vulnerability assessment content, wherein the identifying the portion of the vulnerability assessment content comprises identifying the portion of the vulnerability assessment content based on the mapping.

4. The method of claim 1, further comprising:
determining a difference between a first version of the vulnerability assessment content and a second version of the vulnerability assessment content, wherein the identifying the portion of the vulnerability assessment content is based on the difference.

5. The method of claim 1, wherein:
the vulnerability assessment content comprises vulnerability assessment definitions for vulnerabilities including logical statements defining an expected state of the endpoint by specifying the attribute and an expected state of the attribute,
the identifying the portion of the vulnerability assessment content comprises identifying a vulnerability assessment definition in the vulnerability assessment definitions, and
the performing the vulnerability assessment comprises performing the vulnerability assessment using the vulnerability assessment definition.

6. The method of claim 1, wherein:
the vulnerability assessment content comprises a vulnerability assessment definition for a vulnerability including logical statements defining an expected state of the endpoint by specifying the attribute and an expected state of the attribute,
the identifying the portion of the vulnerability assessment content comprises identifying a logical statement in the logical statements, and
the performing the vulnerability assessment comprises performing the vulnerability assessment using the logical statement.

7. The method of claim 1, wherein the change in the vulnerability assessment content comprises at least one of:
a creation of a new vulnerability assessment definition,
a change to an existing vulnerability assessment definition, or
a change to a sub-construct of the existing vulnerability assessment definition.

8. The method of claim 1, wherein the attribute comprises at least one of:
an operating system property, or
an installed application property.

9. The method of claim 1, wherein the performing the vulnerability assessment comprises determining whether a value of the attribute is greater than, less than, or equal to an expected value of the attribute indicated by the portion of the vulnerability assessment content.

10. The method of claim 1, further comprising:
outputting, based on the performed vulnerability assessment, an indication as to whether the endpoint is vulnerable to a known vulnerability.

11. The method of claim 1, wherein the vulnerability assessment content comprises the portion of the vulnerability assessment content and a second portion of the vulnerability assessment content, and wherein the performing the vulnerability assessment comprises performing the vulnerability assessment using the portion of the vulnerability assessment content while skipping the second portion of the vulnerability assessment content.

12. The method of claim 1, wherein the obtaining the indication of the change comprises detecting the change at the endpoint.

13. The method of claim 1, wherein the performing the vulnerability assessment comprises performing the vulnerability assessment during an assessment instance of an assessment cycle of the vulnerability assessment engine.

14. The method of claim 1, wherein the vulnerability assessment content comprises a plurality of tests, and wherein the portion of the vulnerability assessment content comprises a test in the plurality of tests.

15. The method of claim 1, wherein performing the vulnerability assessment of the endpoint is additionally based on the attribute of the endpoint.

16. A system, comprising:
a processing device; and
a memory to store instructions that, when executed by the processing device, cause the processing device to:
obtain an indication of a change in at least one of:
an attribute of an endpoint, or
vulnerability assessment content of a vulnerability assessment engine;
identify, based on the indication of the change, a portion of the vulnerability assessment content; and
perform, via the vulnerability assessment engine, a vulnerability assessment of the endpoint using the portion of the vulnerability assessment content.

17. The system of claim 16, wherein the processing device is further to:
generate a mapping between the attribute of the endpoint and an object identifier (ID) corresponding to the portion of the vulnerability assessment content, wherein to identify the portion of the vulnerability assessment content, the processing device is to identify the portion of the vulnerability assessment content based on the mapping.

18. The system of claim 16, wherein the processing device is further to:
determine a difference between a first version of the vulnerability assessment content and a second version of the vulnerability assessment content, wherein to identify the portion of the vulnerability assessment content, the processing device is to identify the portion of the vulnerability assessment content based on the difference.

19. A non-transitory computer readable medium, having instructions stored thereon which, when executed by a processing device, cause the processing device to:
obtain an indication of a change in at least one of:
an attribute of an endpoint, or
vulnerability assessment content of a vulnerability assessment engine;
identify, by the processing device and based on the indication of the change, a portion of the vulnerability assessment content; and
perform, via the vulnerability assessment engine, a vulnerability assessment of the endpoint using the portion of the vulnerability assessment content.

20. The non-transitory computer readable medium of claim 19, wherein the instructions, when executed by the processing device, cause the processing device further to:
generate a mapping between the attribute of the endpoint and an object identifier (ID) corresponding to the portion of the vulnerability assessment content, wherein to identify the portion of the vulnerability assessment content, the instructions, when executed by the processing device, cause the processing device to identify the portion of the vulnerability assessment content based on the mapping.
